(19) United States
(12) Patent Application Publication
(10) Pub. No.: US 2026/0286204 A1
(43) Pub. Date: Sep. 24, 2026

(54) PHASE CHANGE MATERIALS WITH ENHANCED THERMAL STABILITY

(71) Applicant: THE BOARD OF TRUSTEES OF THE UNIVERSITY OF ILLINOIS, Urbana, IL (US)

(72) Inventors: Paul V. BRAUN, Champaign, IL (US); Sung Bum KANG, Champaign, IL (US); Jay Matthew TAYLOR, Urbana, IL (US); Sanjiv SINHA, Champaign, IL (US); Daniel Hwai-En HSIEH, Urbana, IL (US); Youngmun LEE, Champaign, IL (US)

(73) Assignee: THE BOARD OF TRUSTEES OF THE UNIVERSITY OF ILLINOIS, Urbana, IL (US)

(21) Appl. No.: 19/473,851

(22) PCT Filed: Apr. 10, 2024
(86) PCT No.: PCT/US2024/023852

§ 371 Date: Oct. 9, 2025

Related U.S. Application Data
(60) Provisional application No. 63/495,434, filed on Apr. 11, 2023.

(51) Int. Cl. C09K 5/06

(52) U.S. Cl. CPC C09K 5/063

(57) ABSTRACT

Sodium sulfate hydrate is used as a phase change material (PCM) for thermal energy storage due to its high energy storage capacity, low cost, and abundance. However, there are two major problems, supercooling and phase segregation upon cycling. To address supercooling, various nucleating agents can be added. This method promotes formation of crystals and reduces formation of a metastable supercooled liquid. Phase segregation occurs when a PCM undergoes repeated melting and solidification cycles, leading to a separation of the material into its constituent phases. In the case of sodium sulfate hydrate, this can lead to the separation of the anhydrous form of the material from the hydrated form, resulting in a loss of energy storage capacity and reduced thermal performance. To address these issues, this invention provides a phase change hydrogel comprising sodium sulfate, alginate, and molecules of glycine, wherein the molecules of glycine are zwitterions.

### RELATED APPLICATIONS

This application claims priority under 35 U.S.C. § 119(e) to U.S. Provisional Patent Application No. 63/495,434, filed Apr. 11, 2023, which is incorporated herein by reference.

### GOVERNMENT SUPPORT

This invention was made with government support under DE-EE0009680 awarded by the Department of Energy. The government has certain rights in the invention.

### BACKGROUND OF THE INVENTION

Phase change materials (PCMs) are substances that can store and release thermal energy during phase transitions, such as melting and solidification. PCMs are used in various applications, including thermal energy storage, temperature regulation, and heat management. However, some PCMs have limitations, such as low thermal conductivity and poor stability, which limit their effectiveness.

One promising class of PCMs is salt hydrates, which are composed of a salt and water molecules such as sodium sulfate decahydrate (SSD). Salt hydrates have high energy storage densities, good thermal conductivities, and are abundant and low-cost. However, there is still room for improvement in the design and synthesis of salt hydrates as PCMs to optimize their performance.

Supercooling occurs when a PCM is cooled below its melting temperature without undergoing solidification. This can occur when there are no crystal nuclei present to serve as the starting point for the growth of solid crystals. As a result, the PCM material remains in a liquid state, even though it has cooled below its melting temperature.

Supercooling is detrimental to the performance of salt-hydrated PCMs. When salt-hydrated PCMs experience supercooling, several problems can arise that can reduce the effectiveness of the PCM-based system for thermal energy storage and regulation. One such problem is delayed melting, which can lead to a delay in the release of stored thermal energy. This can reduce the overall effectiveness of the PCM-based system for thermal energy regulation.

Another problem associated with supercooling is reduced energy storage capacity. This occurs when supercooling reduces the amount of energy that can be stored during solidification. As a result, the overall thermal performance of the PCM-based system can be reduced.

Supercooling can also cause phase separation within the PCM, where the salt and water molecules separate into distinct phases. This can lead to a loss of stability and performance of the PCM and can even lead to the formation of crystals that can damage the system.

To achieve optimal performance, it is important to avoid supercooling in salt-hydrated PCMs. This can be done by selecting appropriate salts, controlling the cooling rate during solidification, and monitoring the system to prevent phase separation and other problems. By avoiding supercooling, the performance and effectiveness of salt-hydrated PCMs can be maximized for thermal energy storage and regulation in various applications.

The supercooling mechanism of SSD is a result of strong electrostatic attraction, hydrogen bonding, and hydration shell formation around ions. This makes it difficult for the SSD system to nucleate and transition into a crystalline state. The water molecules in SSD become sluggish, leading to slow dynamics. To achieve crystallization in SSD, it is necessary to introduce a nucleator such as borax, which has been shown to accelerate nucleation. The RDF (radial distribution function) of hydrogen (of water) with sodium and sulfate ions shows that the sulfate ions are closer to the hydrogen of water, forming a stronger cluster compared to the sodium ions. This is due to the electrostriction effect, which results in water clusters binding strongly with high charge density anions such as SO4⁻². The presence of a larger hydration shell around SO4⁻² than Na+ ions also contributes to a higher RDF peak for H—S compared to H—Na. The SSD system remains in a perpetual supercooled state, making it difficult to achieve homogeneous nucleation in pure SSD samples.

Salt hydrated phase change materials can also have lower thermo cyclic stability compared to other types of PCMs, which can limit their usefulness in some applications. Thermo cyclic stability refers to a PCM's ability to maintain its thermal properties over multiple melting and solidification cycles, without significant degradation or changes in performance.

A nucleating agent can help to reduce the supercooling of PCM by promoting the formation of crystal nuclei, which provide a surface for the PCM molecules to assemble and transition into a solid state during the solidification process.

By adding a nucleating agent to the PCM material, the formation of crystal nuclei can be promoted, even at higher temperatures. This reduces the energy barrier required for solidification and can help to reduce the degree of supercooling.

In addition, the presence of crystal nuclei can also help to promote uniform solidification throughout the PCM material. This can help to reduce the formation of large crystals or impurities that can negatively impact the thermal performance and stability of the PCM material over multiple melting and solidification cycles.

Without a nucleating agent, the crystal size and distribution of SSD can be unpredictable and inconsistent. When SSD crystals are formed without a nucleating agent, they grow in a haphazard manner, resulting in crystals of varying sizes and shapes. This can lead to difficulties in handling the PCM, as well as in controlling its thermal properties. The presence of larger crystals can also negatively impact the cycling stability of the PCM, as they may be more prone to cracking or breaking apart during thermal cycling.

Overall, the addition of a nucleating agent can help to improve the efficiency and effectiveness of a PCM material for thermal energy storage and regulation by reducing supercooling and promoting uniform solidification.

One of the main reasons why salt hydrated PCMs can have lower thermo cyclic stability is due to the formation of crystal nuclei during the solidification process. As mentioned earlier, crystal nuclei are important for promoting solidification and improving the energy storage capacity of the PCM material. However, if the concentration of crystal nuclei is too high, it can lead to the growth of large crystals and the accumulation of impurities, which can reduce the thermo cyclic stability of the PCM material over multiple melting and solidification cycles.

In addition, salt hydrated PCMs can also be prone to water loss or gain, which can lead to changes in the concentration of the salt and the physical properties of the PCM material. This can occur due to the hygroscopic nature of many salt hydrates, which can absorb or release water vapor from the surrounding environment. Over time, this can lead to changes in the melting and solidification temperatures, as well as changes in the thermal energy storage capacity of the PCM material.

Therefore, research on salt hydrate-based PCMs is motivated by the need to develop effective and efficient thermal energy storage solutions for various applications, such as building heating and cooling systems, solar energy storage, and waste heat recovery. By understanding the properties and behavior of salt hydrates as PCMs, researchers can design and optimize these materials for specific applications and improve their overall performance.

### SUMMARY

This disclosure provides an improved phase change material composed of sodium sulfate and glycine. This composition can be combined with alginate to form a hydrogel comprising a crosslinked three-dimensional network with improved thermo-cyclic stability.

Accordingly, this disclosure provides a phase change composition comprising molecules of sodium sulfate and molecules of an amino acid, wherein the amino acid is at about its isoelectric point.

This disclosure also provides a phase change hydrogel comprising sodium sulfate decahydrate, alginate, and molecules of glycine, wherein the molecules of glycine are zwitterions.

Additionally, this disclosure provides a method for releasing and storing thermal energy, comprising:
a) adapting a heat exchanger to the phase change composition or to the phase change hydrogel described above; and
b) exposing the composition or hydrogel to an environment wherein the temperature fluctuates;
wherein the composition or the hydrogel releases thermal energy to the heat exchanger when the composition or the hydrogel solidifies; and
the composition or the hydrogel withdraws thermal energy from the heat exchanger when it melts.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Optical images of SSD with glycine at various pH levels.

FIG. 2. Zeta potential of Sodium sulfate and Sodium sulfate with glycine. The region ~pH<5 signifies the area where cations dominate in glycine, the region ~pH 5-8 represents the zwitterionic form of glycine, and the region ~pH>8 indicates the presence of anions.

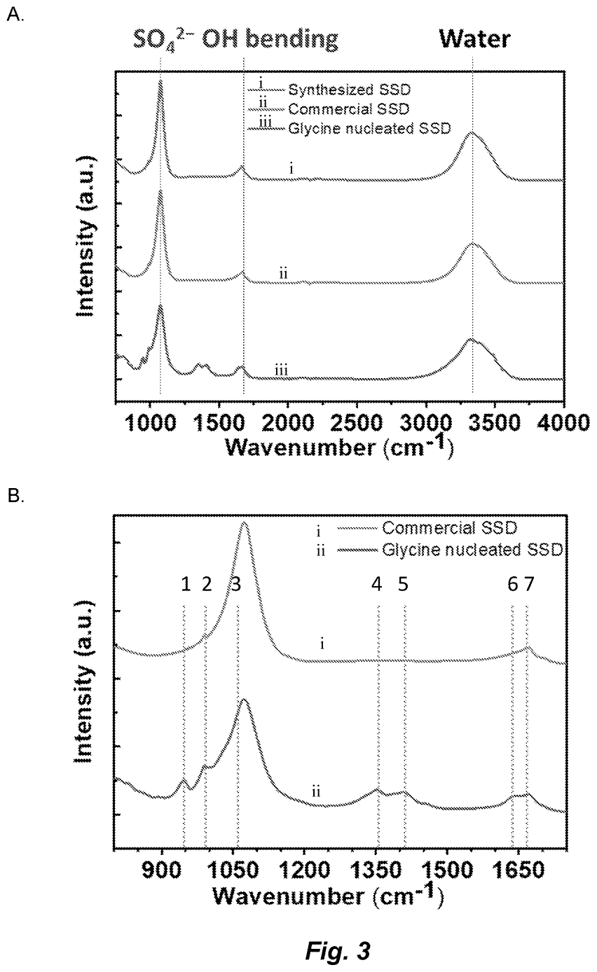

FIG. 3. FT-IR Spectrum of synthesized SSD, Commercial SSD, and glycine nucleated SSD (a). Expanded region annotated (b): 1) CCN . . . HO_{water} (CCN symmetric stretch, shifted by hydrogen bonding); 2) CCN . . . HO_{water} (CCN asymmetric stretch, shifted by hydrogen bonding); 3) NH₃⁺ (NH₃⁻ rocking); 4) CH₂ twist; 5) COO symmetric stretch; 6) O—H . . . N (OH bending, shifted by hydrogen bond); 7) OH bending.

FIG. 4. Temperature curve of SSD without glycine by T-history method (a) and DSC method (b).

FIG. 5. Temperature curve of SSD with glycine by T-history method (a) and DSC method (b). This first study shows supercooling at less than 4° C. and demonstrates it on both T-history and DSC, which is highly reliable.

FIG. 6. DSC data with melting and cooling curve—dashed vertical line is on-set temperature (a) and extracted energy storage capacity (b). On-set temperature and stored energy density are maintained over cycles. A 3D network composed of Alg, binder, and nucleating agent—Gly, works perfectly for SSD.

FIG. 7A-C. T-history data with melting and cooling curve—dashed horizontal line is on-set temperature (a) extracted energy storage capacity (b), and latent heat (c) (which is equivalent to energy storage capacity). On-set temperature and stored energy density are maintained over cycles. A 3D network composed of Alg, binder, and nucleating agent—Gly, works perfectly for SSD.

FIG. 8A-B. SEM image (left) showing sodium signal from SSD and carbon signal from alginate, and EDS image (right) of Alg-gly-SSD, both at zero cycles (a). Optical images of SSD crystal after 10-50 repetitions of the cycle—bottom right is EDS image at 50^{th} cycle(b).

FIG. 9. FT-IR spectrum of Alg-gly-SSD and dried Alg-gly-SSD (after dehydration) with 0 cycle and after 100 cycles.

FIG. 10. At 20° C., the complex viscosity (a) and storage modulus (b) of Alg-gly-SSD and Alg-SSD were measured. Then, the samples are heated up to 40° C., making phase transition of SSD, and transformed into Alg-gly-SS-water and Alg-SS-water. After that, the complex viscosity and storage modulus of Alg-gly-SS-water and Alg-SS-water were measured.

FIG. 11A-B. Rheological analysis for alginate and SSD composition (a), and alginate, glycine, and SSD composition (b).

FIG. 12. Graph showing storage modulus versus angular frequency.

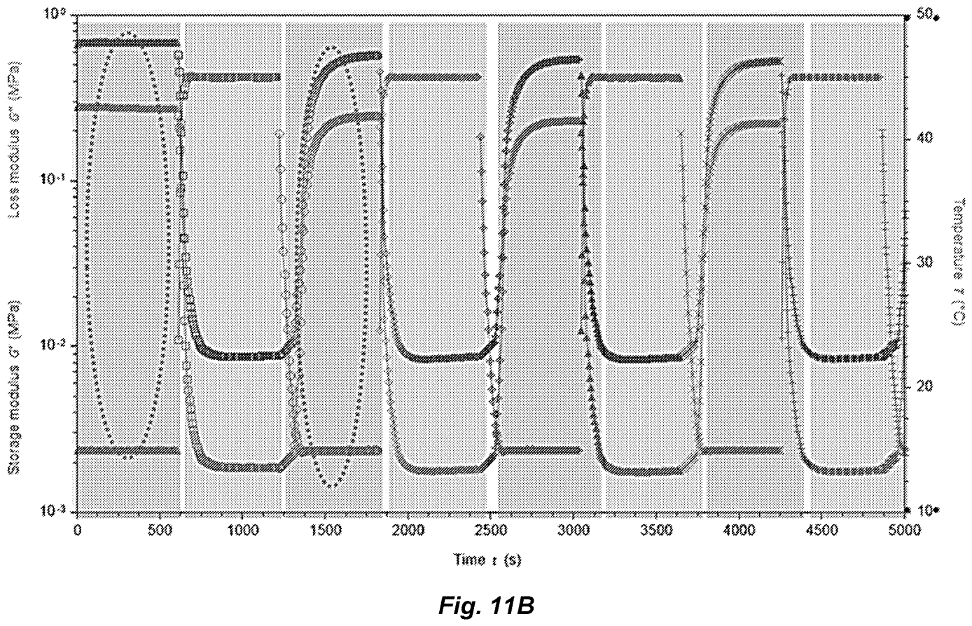

FIG. 13. Graphs showing temperature versus time without (left panel) and with (right panel) PCM. The black dashed line on the graph indicates the temperature range that is comfortable for humans, which is around 20 degrees Celsius. Without phase change material, a significant amount of energy is required to cool down or heat up to this temperature. However, when PCM is present, only a small amount of energy is needed.

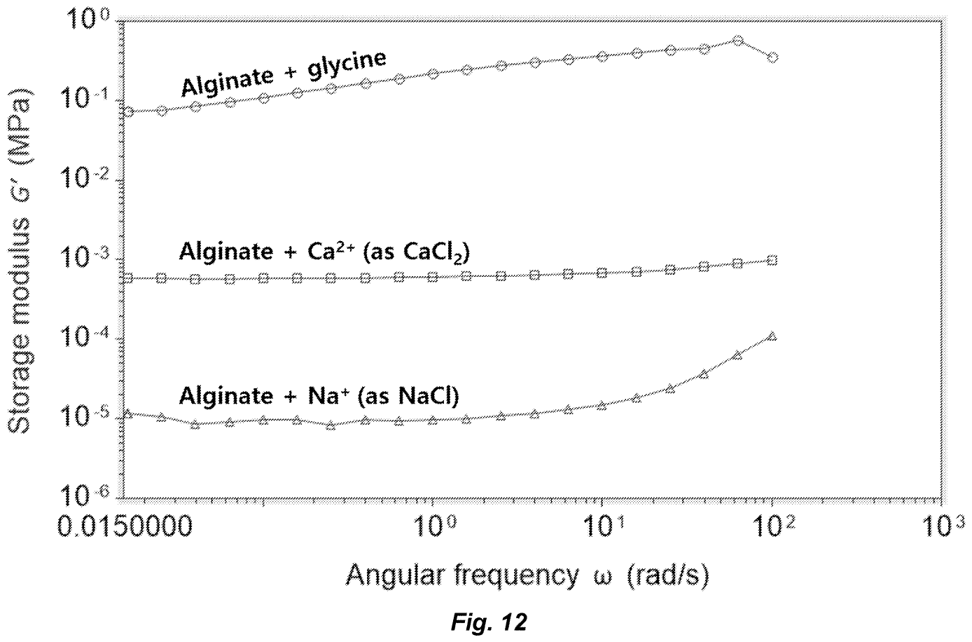

FIG. 14. Gravimetric energy density in melting (a). Gravimetric energy density in freezing (b).

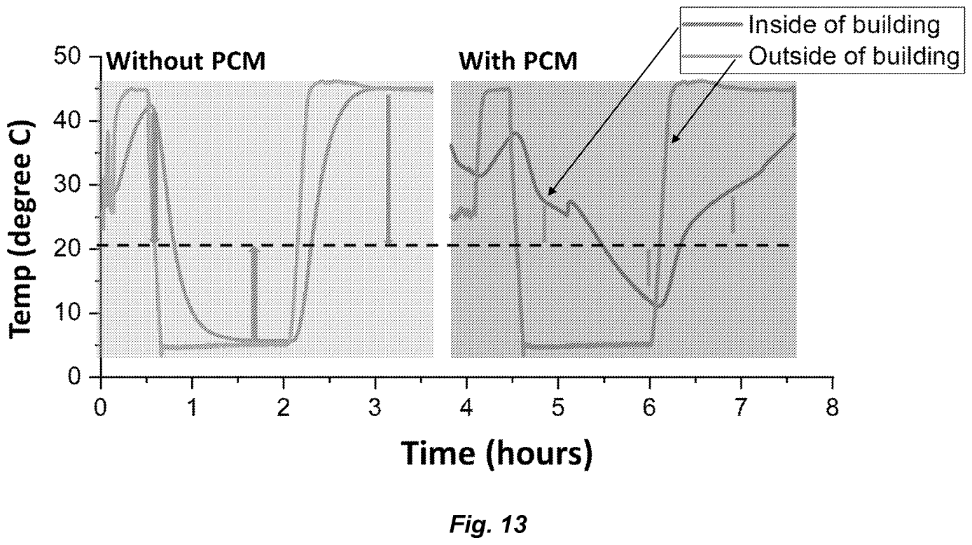

FIG. 15. Thermal conductivity of hydrogel.

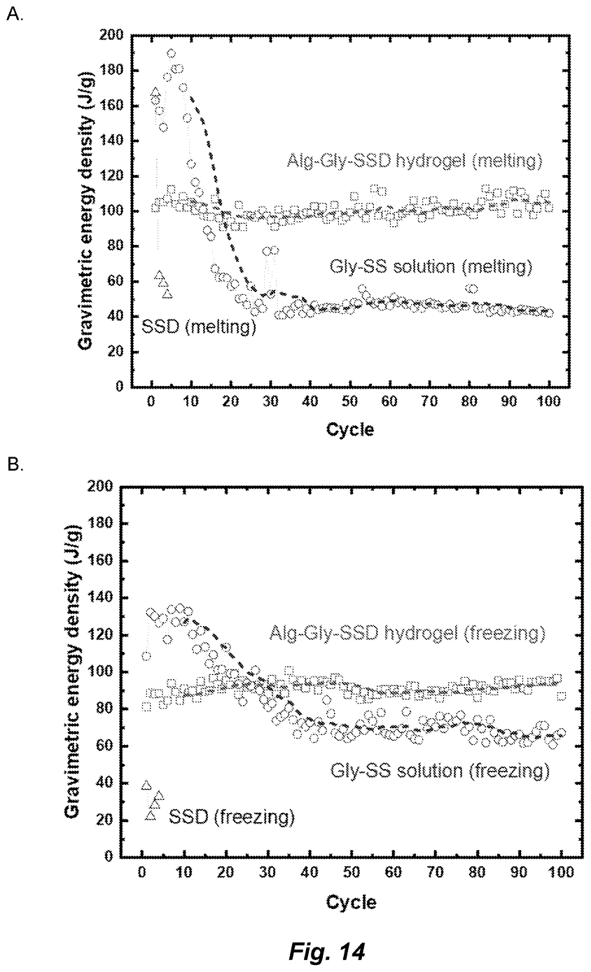

FIG. 16. Glycine-nucleated sodium sulfate decahydrate (SSD) systems. A notable observation is the significantly slower rate of water evaporation at room temperature compared to pure SSD. It effectively becomes nucleated with glycine molecules, which then engage in extensive hydrogen bonding with surrounding water molecules. Also, it leads to the formation of a hydrated layer around the SSD crystals. This layer serves as a physical barrier, further impeding the escape of water molecules and reducing the rate of evaporation. The interaction between glycine and water molecules in SSD systems introduces a significant modification to the hydration dynamics, leading to a marked decrease in the rate of water evaporation.

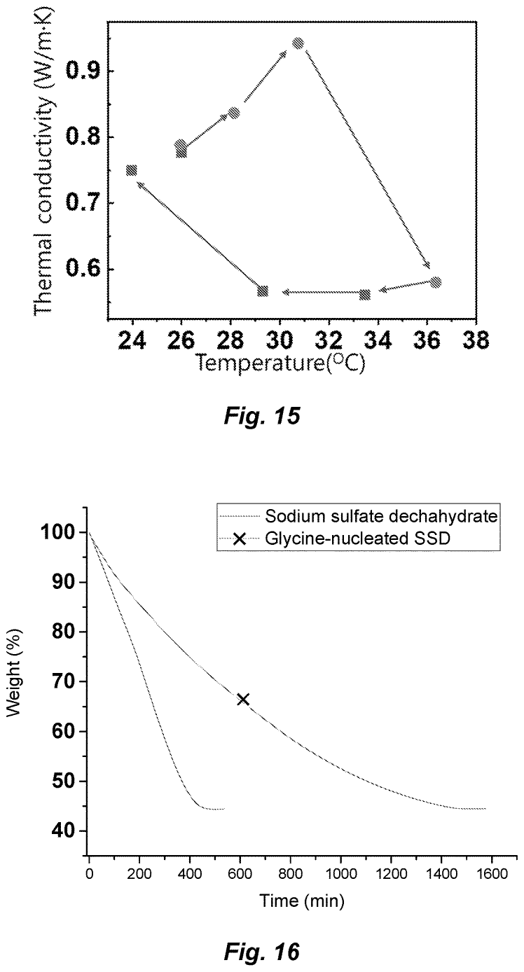

### DETAILED DESCRIPTION

The addition of glycine as a nucleating agent plays a crucial role in reducing supercooling of a PCM. Glycine facilitates nucleation of the PCM, which leads to the formation of crystals at a higher temperature, reducing the supercooling and thus increasing the effectiveness of the PCM for thermal energy storage. Our hypothesis is that glycine interacts electrostatically with the PCM and provides nucleation sites for the growth of crystals or reduces the surface energy of the crystals. Both these effects could reduce supercooling.

With the addition of glycine as a nucleating agent, the PCM exhibited a significantly reduced supercooling of only 4° C., which is a record-low supercooling effect in the PCM field. This remarkable result was achieved by promoting PCM nucleation, which prevented the PCM from undergoing extensive supercooling before solidification. Using T-history measurements, the PCM with the nucleating agent showed a clear nucleation point, indicating the successful promotion of nucleation. Using DSC measurements, the PCM with the nucleating agent showed a higher onset temperature, indicating reduced supercooling.

Also, we observed that the combination of alginate and glycine resulted in the formation of a stable 3D network. This network resulted in stable sodium sulfate decahydrate (SSD) crystal formation and melting. Even after 50 cycles, the network remained stable (did not flow) and was able to maintain its thermal cycling functionality. These findings suggest that the alginate and glycine combination can be used for the development of stable and reliable PCM systems. It is our hypothesis that the glycine leads to formation of intermolecular crosslinks between alginate molecules, resulting in a three-dimensional network structure. This network structure provided a scaffold to support and confine the SSD crystals and to prevent the SSD crystals from moving from one region of the network to another.

Compared to previous approaches that focused on the thickening or encapsulation of PCM materials, this physical structuring approach provides a more stable and reliable method for enhancing thermo-cyclic stability. The results of this study suggest that physical structuring using 3D networks can be a promising approach for developing PCM systems with improved performance and stability. It is important that the crosslinking is not due to a covalent bond formation, but rather a reversible bond, which allows the network to ‘self-heal’ if the growing crystal formed during cooling breaks any crosslinks.

Energy Storage for Cold Start Improvement. The challenge of higher oil viscosity and decreased combustion efficiency during cold starts in vehicles is a significant issue that impacts fuel economy and emissions. The phase change properties of the hydrogel described herein can be strategically employed to maintain component warmth for extended periods post-engine shutdown, aiming to mitigate the cold-start penalty. Unlike traditional PCMs, the melting temperature of the hydrogel can be finely adjusted to provide sufficient warmth without excessive heat loss, thus extending the duration over which component temperatures are maintained. This approach not only promises to decrease CO and HC emissions during startup but also to enhance fuel economy by preheating essential components like the coolant and gearbox oil, mirroring the benefits observed in studies with conventional PCMs.

Cabin Climate System Thermal Buffering. The described hydrogel also offers a solution to the significant energy used in adjusting the vehicle's cabin temperature during cold starts. Its application in thermal buffering systems can substantially reduce energy-draw from batteries in EVs and PHEVs, which is critical for maintaining vehicle efficiency and occupant comfort. By integrating, for example, Gly-Alg-SSD into a vehicle's cabin cooling or heating system, it's possible to provide immediate thermal relief during idling periods or reduce the cooling/heating load during start-up after brief vehicle-off intervals. This PCM's phase change temperature and thermal conductivity can be optimized to match the expected load profile, ensuring efficient thermal management without compromising passenger comfort.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below or otherwise described herein. The alkyl can also be optionally partially or fully unsaturated. As such, the recitation of an alkyl group can include an alkenyl group or an alkynyl group. The alkyl can be a monovalent hydrocarbon radical, as described and exemplified above, or it can be a divalent hydrocarbon radical (i.e., an alkylene).

The term “heteroatom” refers to any atom in the periodic table that is not carbon or hydrogen. Typically, a heteroatom is O, S, N, P. The heteroatom may also be a halogen, metal or metalloid.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

A non-polar solvent is a liquid or solvent that has a low or non-existing dipole moment and is missing any partial positive or negative charges. Generally, it has small differences in electronegativity between atoms in the solvent molecule and has a low dielectric constant. A non-polar solvents cannot effectively dissolve a polar compound. Examples of a non-polar solvent includes alkanes, toluene, chloroform and diethyl ether.

The term “molecular weight” for the polymers disclosed herein refers to the average number molecular weight (Mₙ). The corresponding weight average molecular weight (M_{w}) can be determined from other disclosed parameters by methods (e.g., by calculation) known to the skilled artisan.

The term “alginate” refers to the salt form of alginic acid which is a naturally occurring polysaccharide that has carboxylic acid groups.

A hydrogel is a biphasic material comprising mixture of solids, such as polymers, minerals and salts, and at least some volume of interstitial fluid composed completely or mainly of water. The crosslinks which bond the polymers of a hydrogel can be categorized as chemical hydrogels or physical hydrogels. Chemical hydrogels have covalent cross-linking bonds that can be reversible or irreversible, such as ester or disulfide bonds. Physical hydrogels have non-covalent bonds. Physical hydrogels are reversible by changing an external stimulus such as pH, ion concentration, or temperature. Physical crosslinks consist of, for example, hydrogen bonds, ionic bonds, coulombic or hydrophobic interactions, or chain entanglements.

The hydrogel described herein has enhanced thermal conductivity due to a high water content, which improves heat transfer capabilities compared to standard organic PCMs, leading to more efficient energy storage and release. Containment of the hydrogel within the heat exchanger or heat pump involves special cartridges, panels, or pouches that can be filled with the hydrogel and then integrated into a heat exchanger structure, where the hydrogel is in optimal contact with both the heat source and the medium being cooled or heated, to facilitate efficient thermal exchange. Another approach is to incorporate the hydrogel directly into the heat exchanger channels. This method would involve lining the channels with the hydrogel or creating a channel that allows the fluid medium to flow through the hydrogel itself. Maximizing the surface area available for heat exchange could involve creating a textured surface within the hydrogel containment units or employing a matrix-like structure within the channels to increase the interface between the hydrogel and the heat exchange medium.

### Embodiments of the Technology

1. A phase change composition or hydrogel comprising sodium sulfate, or molecules of sodium sulfate and molecules of an amino acid wherein the amino acid is at about its isoelectric point. In various embodiments the composition or hydrogel further comprises a polysaccharide. In some preferred embodiments, the polysaccharide contributes to the thermal cyclic stability, for example, enabling the alg-gly-ss to retain its thermal energy storage capacity through over 100 cycles. In some preferred embodiments, the polysaccharide in the hydrogel reduces the propensity of phase separation. In some embodiments, the polysaccharide is a salt. In some embodiments, the polysaccharide is a lithium, sodium, potassium, calcium, or magnesium salt.
2. The phase change composition or hydrogel of embodiment 1, wherein the sodium sulfate is hydrated. In other embodiments, the number of hydrating water molecules is 1, 2, 3, 4, 5, 6, 7, 8, 9, 10, 11, 12, 13, 14, 15, 15-20, or more. In some preferred embodiments, the sodium sulfate is sodium sulfate decahydrate.
3. The phase change composition or hydrogel of embodiment 1 or 2, wherein the amino acid is (molecular) alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, or valine. In some embodiments, the amino acid is the L-amino acid or the D-amino acid. In other embodiments the amino acid is naturally occurring, non-naturally occurring, or synthetic.
4. The phase change composition or hydrogel of any one of embodiments 1-3, wherein the amino acid is a zwitterion, a cation, an anion, or a combination thereof.
5. The phase change composition or hydrogel of any one of embodiments 1-4, wherein the composition has a pH of about 4.5 to about 8.0. In some embodiments, the pH is about “m”, wherein “m” is 1, 2, 3, 4, 5, 6, 7, 8, 9, 10, 11, 12, 13, or 14.
6. The phase change composition or hydrogel of any one of embodiments 1-5, further comprising a polysaccharide. In various embodiments, the polysaccharide is an alginate, hyaluronic acid, chitosan, heparin, or a combination thereof.
7. The phase change composition or hydrogel of any one of embodiments 1-6, wherein the polysaccharide or alginate is cross-linked with molecules of the amino acid or glycine. In various embodiments, the polysaccharide or alginate is cross-linked with molecules of the amino acid or glycine via ionic bonds, electrostatic interactions, or covalent bonds.
8. The phase change composition or hydrogel of any one of embodiments 1-6, wherein the weight ratio of the alginate to the amino acid is about 1.0:0.3 to about 1.0:0.1.
9. The phase change composition or hydrogel of any one of embodiments 1-8, wherein the weight percentage of the amino acid relative to the weight of sodium sulfate is about 2 wt. % to about 20 wt. % or about 4 wt. % to about 16 wt. %. In some embodiments, the weight percentage of the amino acid relative to the weight of sodium sulfate is about 3 wt. %, about 5 wt. %, about 6 wt. %, about 8 wt. %, about 9 wt. %, about 11 wt. %, about 13 wt. %, or about 15 wt. %.
10. The phase change composition or hydrogel of any one of embodiments 1-9, wherein the weight percentage of the amino acid in the composition is about 3 wt. % to about 16 wt. %.
11. The phase change hydrogel of any one of embodiments 1-10, wherein the hydrogel comprises water and the sodium sulfate is hydrated.
12. The phase change hydrogel of any one of embodiments 1-11, wherein the hydrogel has a weight ratio of the alginate to the amino acid of about 1:0.4 to about 1:0.05 or about 1:0.3 to about 1:0.1.
13. The phase change hydrogel of any one of embodiments 1-12, wherein the hydrogel has a weight ratio of the alginate to the amino acid of about 1:1 to about 1:0.2 or about 1:0.9 to about 1:0.3.
14. The phase change hydrogel of any one of embodiments 1-13, wherein the amino acid has a weight percent of about 1 wt. % to about 20 wt. % or about 3 wt. % to about 16 wt. % relative to the weight of sodium sulfate (Na₂SO₄).
15. The phase change hydrogel of any one of embodiments 1-14, wherein the amino acid has a weight percent of about 2 wt. %, about 4 wt. %, about 7 wt. %, about 9 wt. %, about 11 wt. %, about 13 wt. %, about 15 wt. %, about 17 wt. %, or about 20 wt. %, relative to the weight of sodium sulfate (Na₂SO₄).
16. The phase change hydrogel of any one of embodiments 1-15, wherein the polysaccharide has a weight percent of about 10 wt. % to about 45 wt. % or about 13 wt. % to about 41 wt. % relative to the weight of sodium sulfate (Na₂SO₄).
17. The phase change hydrogel of any one of embodiments 1-16, wherein the polysaccharide has a weight percent of about 12 wt. %, about 14 wt. %, about 16 wt. %, about 19 wt. %, about 22 wt. %, about 26 wt. %, about 28 wt. %, about 30 wt. %, about 32 wt. %, about 34 wt. %, about 36 wt. %, about 38 wt. %, or about 40 wt. %, relative to the weight of sodium sulfate (Na₂SO₄).
18. The phase change hydrogel of any one of embodiments 1-17, wherein the sodium sulfate (Na₂SO₄) has a weight percent of about 45 wt. % to about 70 wt. % or about 47 wt. % to about 65 wt. % relative to a weight of water in the hydrogel.
19. The phase change hydrogel of any one of embodiments 1-18, wherein the amino acid is glycine, and the polysaccharide is alginate, wherein the alginate is crosslinked with the glycine.
20. The phase change hydrogel of any one of embodiments 1-19, wherein the weight ratio of the sodium sulfate, the alginate, and the glycine is about 1 part sodium sulfate (Na₂SO₄), about 0.1 parts to about 0.5 parts alginate or about 0.13 parts to about 0.4 parts alginate, and about 0.02 parts to about 0.18 parts or about 0.04 parts to about 0.16 parts glycine.
21. The phase change hydrogel of any one of embodiments 1-20, wherein relative to an amount of water in the hydrogel the weight ratio the sodium sulfate, the alginate, and the glycine is: 1 part water, about 0.2 parts to about 0.9 parts or about 0.4 parts to about 0.7 parts sodium sulfate (Na₂SO₄), about 0.05 parts to about 0.3 parts or about 0.08 parts to about 0.2 parts alginate, and about 0.01 parts to about 0.1 parts or about 0.02 parts to about 0.08 parts glycine.
22. A phase change hydrogel comprising molecules of sodium sulfate (anhydrous or the decahydrate), alginate, and molecules of glycine, wherein the molecules of glycine are zwitterions.
23. The phase change hydrogel of embodiment 22 wherein the alginate is cross-linked with the molecules of glycine.
24. The phase change hydrogel of embodiment 22 or 23 wherein the weight ratio of the alginate to the molecules of glycine is about 1.0:0.3 to about 1.0:0.1.
25. The phase change composition or hydrogel of any one of embodiments 22-24 wherein the weight percentage of the glycine to the sodium sulfate is about 4 wt. % to about 16 wt. %.
26. The phase change hydrogel of any one of embodiments 22-25 wherein the weight percentage of the molecules of glycine in the composition is about 3 wt. % to about 16 wt. %.

In various embodiments, the weight ratio of the major constituents in the phase change hydrogel is about 1 part water (w), about 0.4 parts to about 0.7 parts sodium sulfate (x, anhydrous or the decahydrate), about 0.02 to about 0.08 parts glycine (y), and about 0.08 parts to about 0.2 parts alginate (z). In other embodiments, when w is about 1; x is about 0.1, 0.2, 0.3, 0.4, 0.5, 0.6, 0.7, 0.8, or 0.9; y is about 0.01, 0.02, 0.03, 0.04, 0.05, 0.06, 0.07, 0.08, 0.09, or 0.1; and z is about 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, or 0.25.
27. The phase change hydrogel of any one of embodiments 22-26 wherein the weight ratio of the sodium sulfate, the alginate, and the glycine is about 1.0 part sodium sulfate, about 0.13 parts to about 0.40 parts alginate, and about 0.04 parts to about 0.16 parts glycine.
28. A method for releasing and storing thermal energy, comprising:
   a) adapting a heat exchanger to the phase change composition of any one of embodiments 1-27 or to the phase change hydrogel of any one of embodiments 1-27; and
   b) exposing the composition or hydrogel to an environment wherein the temperature fluctuates;
   wherein the composition or the hydrogel releases thermal energy to the heat exchanger when the composition or the hydrogel solidifies; and
   the composition or the hydrogel withdraws thermal energy from the heat exchanger when it melts.
29. The method of embodiment 28, wherein the amino acid is glycine, and the polysaccharide is alginate, wherein the alginate is crosslinked with the glycine.

In some embodiments, the heat exchanger is configured as or is a heatsink.
30. The method of embodiment 28 or 29 wherein the temperature fluctuates by about ±25° C., about ±20° C., about ±15° C., about ±10° C., or about ±5° C. from the melting temperature of the composition or hydrogel.

In some embodiments, the hydrogel is an integral component of a heat exchanger or heat pump, wherein the hydrogel's thermal properties, such as its ability to undergo phase transitions efficiently, enhance the efficiency of heat exchangers or heat pumps.
31. The phase change hydrogel or method of any one of embodiments 1-30, wherein a wt. % of sodium sulfate in the hydrogel is about 25% to about 50%, about 32% to about 44%, about 30%, about 35%, about 40%, or about 45%.
32. The phase change hydrogel or method of any one of embodiments 1-31, wherein a wt. % of alginate in the hydrogel is about 5% to about 15%, about 7% to about 10%, about 6%, about 8%, about 11%, or about 13%.
33. The phase change hydrogel or method of any one of embodiments 1-32, wherein a wt. % of glycine in the hydrogel is about 1% to about 10%, about 2% to about 6%, about 3%, about 4%, about 5%, or about 7%.

### Results and Discussion

Glycine as a nucleating agent. Glycine is a zwitterionic amino acid that contains both an amino group and a carboxyl group. The presence of these functional groups in glycine makes it an effective nucleating agent for solid-state diffusion (SSD) crystals such as sodium sulfate decahydrate (SSD).

When glycine is introduced into a solution of SSD, it can act as a seed or nucleus around which the SSD crystals can grow. This occurs because the glycine molecules are attracted to the surface of the SSD crystals due to their polar nature. Glycine has polar groups, including the carboxyl and amino groups, that can form hydrogen bonds with water molecules. These interactions can disrupt the hydration shell around the ions in SSD, making the water molecules more mobile and dynamic. This increased mobility can lead to a reduction in supercooling, as the water molecules are more likely to form crystal nuclei and initiate crystallization. Moreover, once the glycine molecules are adsorbed onto the surface of the SSD crystals, they can promote the formation of new crystal nuclei by providing a template or framework for the SSD molecules to organize around as forming hydration shells. It may also reduce the activation energy required for nucleation in SSD by creating pockets of low-energy environments that promote crystal formation.

In addition to providing a nucleation site for SSD crystals, glycine can also influence the size and shape of the resulting crystals. This is because the adsorption of glycine onto the surface of the SSD crystals can affect the kinetics of crystal growth, leading to the formation of smaller and more uniformly sized crystals.

Overall, the use of glycine as a nucleating agent for SSD can result in a more controlled and efficient crystallization process, leading to improved crystal size and distribution.

Morphology of SSD with glycine. At low pH, the amino group of glycine is protonated, resulting in a net positive charge on the molecule. This positive charge can attract sulfate ions, leading to the formation of larger aggregates of glycine sodium sulfate particles.

Conversely, At high pH, the negative charge on the glycine molecule can repel sulfate ions, causing the glycine sodium sulfate particles to become more dispersed and smaller in size. However, the positively charged sodium ions in the solution can be attracted to the negatively charged glycine molecules, which can result in non-uniform distribution and void formation.

At pH 7, glycine exists in its zwitterionic form, meaning it has both a positive and negative charge on different parts of the molecule. The positive charge on the amino group can attract the negatively charged sulfate ions of SSD, while the negative charge on the carboxyl group can attract the positively charged sodium ions of SSD (Chart 1).

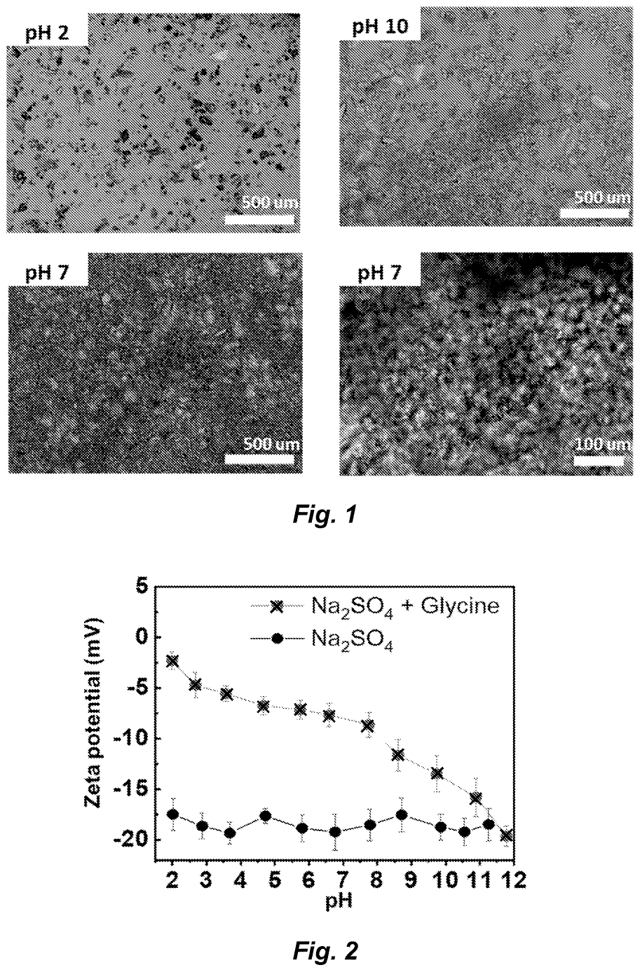

The glycine layer can then act as a template for the nucleation and growth of SSD crystals (FIG. 1). The molecules in the layer can arrange themselves in a way that promotes the formation of crystal nuclei, and the crystals can then grow on these nuclei. Overall, the electrostatic interaction between glycine and SSD is crucial for the nucleation and growth of SSD crystals, and the zwitterionic nature of glycine at pH 7 allows for the maximum interaction between the two molecules.

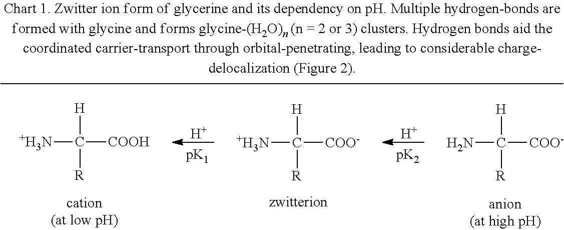

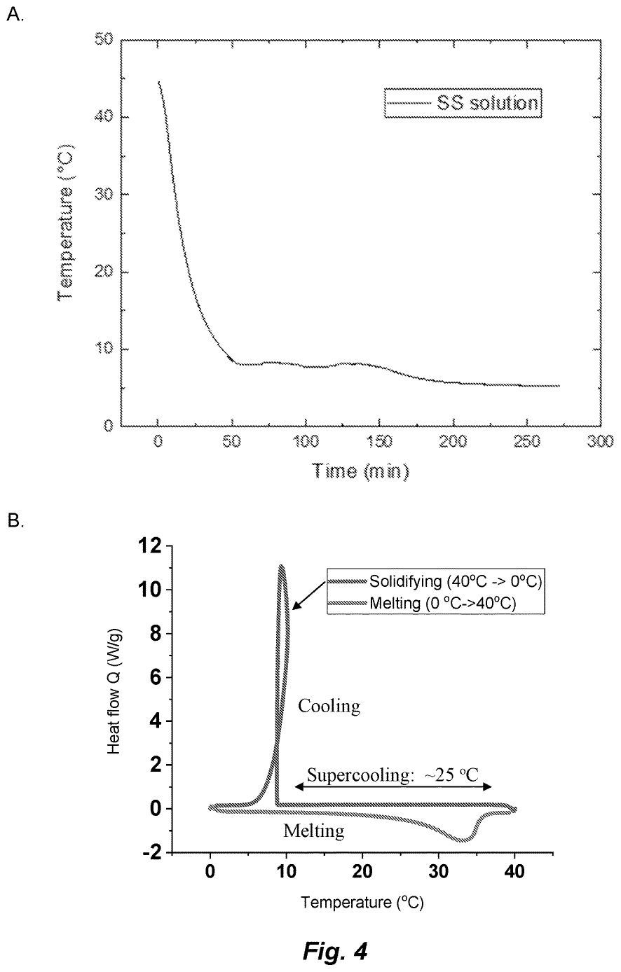

The FT-IR spectrum shows the interaction between sodium sulfate decahydrate and glycine (FIG. 3). The presence of glycine affects the hydrogen bonding between water molecules and the ions in sodium sulfate decahydrate, which increases the mobility of water molecules and promotes crystal nucleation. This is because glycine molecules have polar functional groups, such as the amino and carboxyl groups, which can form hydrogen bonds with water molecules and disrupt the hydration shell around the ions in sodium sulfate decahydrate.

Additionally, glycine acts as a nucleation site for the formation of sodium sulfate decahydrate crystals by promoting the formation of new crystal nuclei and providing a framework for the SSD molecules to organize around as forming hydration shells. The adsorption of glycine onto the surface of the SSD crystals also affects the kinetics of crystal growth, leading to the formation of smaller and more uniformly sized crystals.

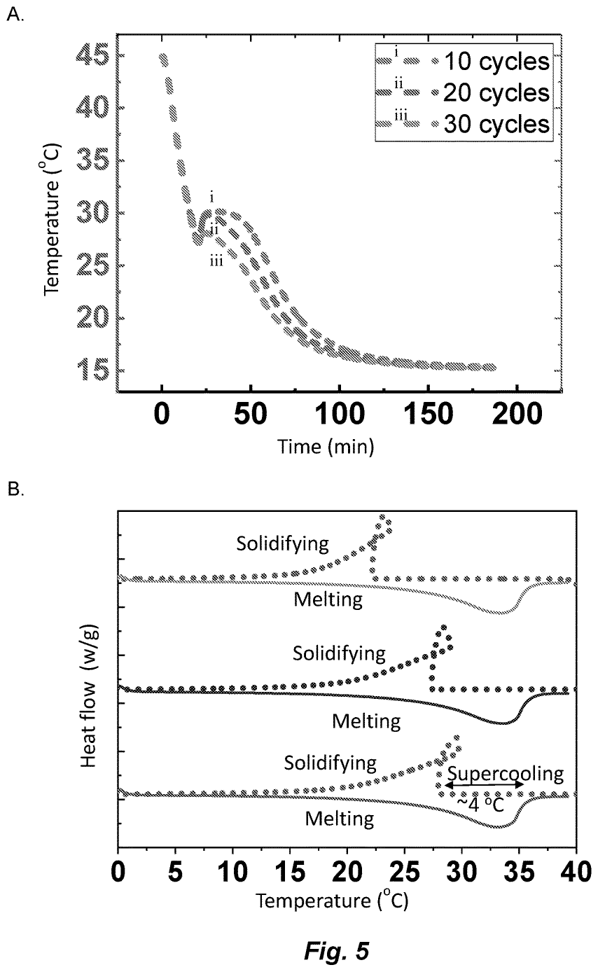

In the T-history test, the temperature of the PCM is decreased at a constant rate, and the PCM should solidify at a certain temperature (FIG. 4A). However, without a nucleating agent, the PCM may remain in the liquid state even at temperatures well below its melting point, which is known as supercooling. In the T-history test, this is observed as a plateau in the cooling curve, indicating that the PCM is still in the liquid state.

In the DSC test, the PCM is subjected to a controlled heating and cooling cycle while the heat flow and temperature changes are recorded (FIG. 4B). Without a nucleating agent, the PCM remains in the liquid state even as it is cooled below its melting point, leading to a large exothermic peak on the cooling curve, indicating that crystallization has occurred after supercooling.

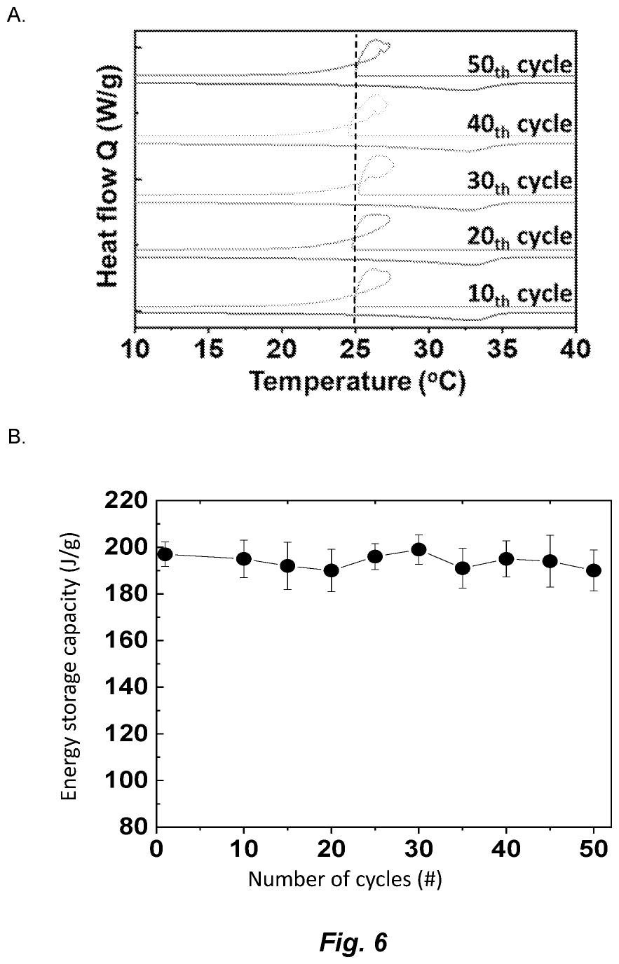

Glycine as a molecular-nucleating agent. The addition of glycine as a nucleating agent plays a crucial role in reducing supercooling of PCM. Glycine can act as a nucleation site for crystal growth and facilitate heterogeneous nucleation, which leads to the formation of small crystals at an earlier stage. This promotes the formation of a crystalline structure with a lower supercooling degree and thus reduces the amount of energy required for solidification (FIG. 5).

Furthermore, glycine can interact electrostatically with the PCM and provide additional nucleation sites for the growth of crystals. The zwitterionic nature of glycine allows for strong electrostatic interactions with the PCM particles, which enhances the likelihood of nucleation and reduces supercooling.

Therefore, With the addition of glycine as a nucleating agent, the PCM exhibited a significantly reduced supercooling of only 4° C., which is a record-low supercooling in the PCM field. This remarkable result was achieved by promoting heterogeneous nucleation, which prevented the PCM from undergoing extensive supercooling before solidification. In the T-history measurement, the PCM with the nucleating agent showed a clear nucleation point, indicating the successful promotion of nucleation. In the DSC measurement, the PCM with the nucleating agent showed a higher onset temperature, indicating reduced supercooling.

Crosslinked alginate with glycine-SSD. Alginate can crosslink with glycine and sodium sulfate. Alginate is a biopolymer derived from seaweed, and it contains reactive groups such as carboxyl and hydroxyl groups that can form ionic bonds with cations like sodium ions.

Glycine, on the other hand, is an amino acid that can form peptide bonds with other amino acids and reactive groups like aldehydes and ketones. When glycine is present in the solution with alginate, it can form crosslinks with the alginate through its carboxyl and amine groups.

Sodium sulfate is a salt that can also participate in crosslinking reactions with alginate. When dissolved in water, sodium sulfate dissociates into its constituent ions, sodium and sulfate. The sulfate ions can form ionic bonds with the carboxyl groups on the alginate molecules, leading to crosslinking.

Therefore, a mixture of alginate, glycine, and sodium sulfate can undergo crosslinking reactions to form a stable gel (Chart 2).

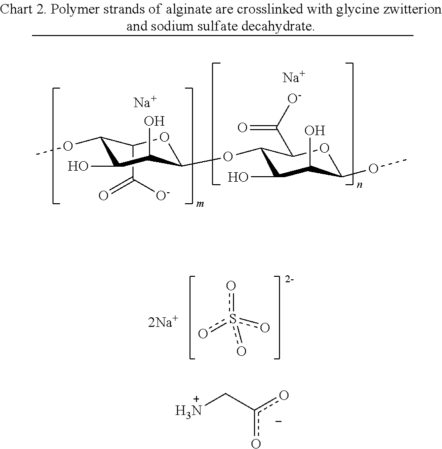

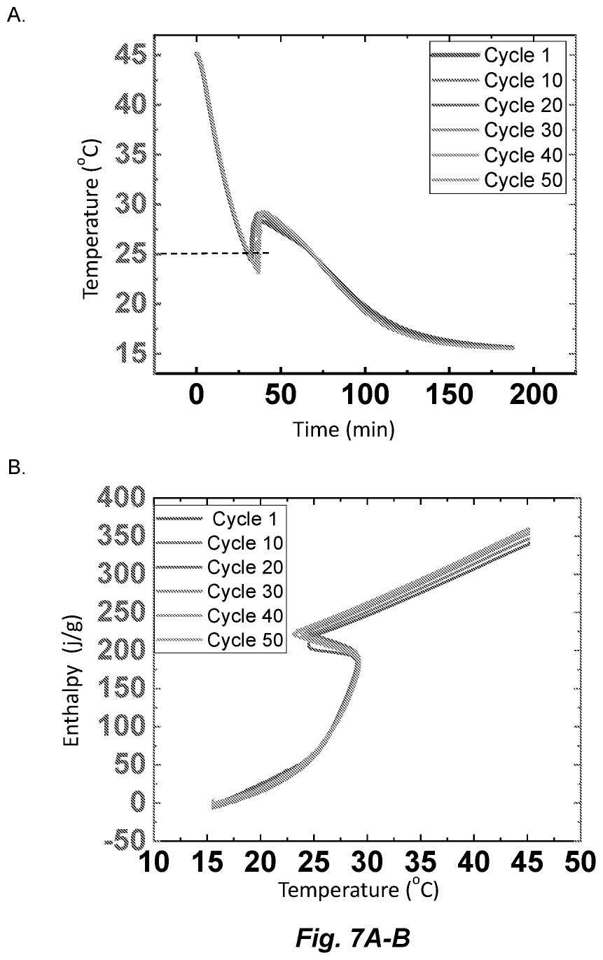

In DSC data, the thermophysical properties of Alg-gly-SSD can be observed, including its melting and crystallization behavior. The data can show that Alg-gly-SSD exhibits stable thermal properties over 50 cycles, with little to no change in melting or crystallization temperature, indicating its excellent thermal stability. Moreover, the Alg-gly-SSD demonstrated a consistent enthalpy of fusion during each cycle, indicating the preservation of the PCM's thermal energy storage capability over repeated thermal cycling. This consistency in enthalpy values is a key indicator of the stability of the PCM, as any degradation or change in the chemical structure of the PCM would result in a change in the enthalpy of fusion (FIG. 6).

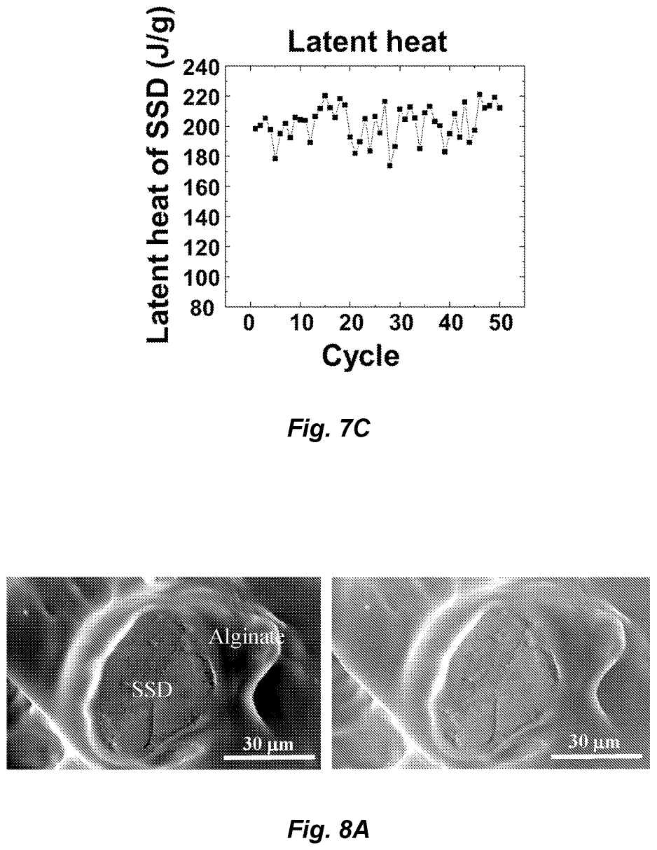

Similarly, In T-history data, the thermal behavior of Alg-gly-SSD during thermal cycling can be observed. The data can show that Alg-gly-SSD maintains stable thermal properties even after 50 thermal cycles, with little to no change in its nucleation behavior or supercooling. Therefore, the Alg-gly-SSD demonstrated a stable nucleation point during each cycle, further indicating the preservation of the PCM's thermal storage performance (FIG. 7).

Overall, the consistent enthalpy values and stable nucleation point observed in the DSC and T-history analysis demonstrate the excellent thermal stability of the Alg-gly-SSD PCM over 50 thermal cycles. This enhanced thermal stability, combined with the record-low supercooling and high thermal energy storage capacity, makes the Alg-gly-SSD PCM a promising candidate for use in various thermal energy storage applications.

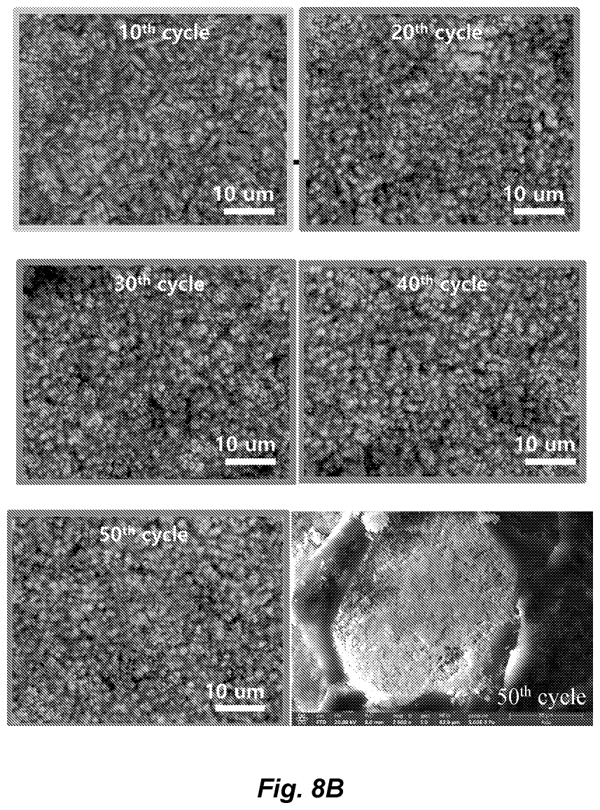

SEM images of Alg-gly-SSD after 50 thermal cycles showed no significant changes in the morphology or particle size distribution, indicating that the crosslinked alginate and nucleating agent successfully prevented particle aggregation and coalescence during repeated heating and cooling cycles. When comparing the SEM images of Alg-gly-SSD 0 cycle (as-prepared) and 50 cycles, there were no significant differences in the particle size or morphology, suggesting that the thermal stability of Alg-gly-SSD was maintained even after prolonged thermal cycling (FIG. 8).

It was observed that the combination of alginate and glycine resulted in the formation of a stable 3D network. This network was able to confine the SSD crystal inside it effectively. Even after 50 cycles, the structure of the network remained stable and was able to maintain its functionality. These findings suggest that the alginate and glycine combination can be a promising approach for the development of stable and reliable PCM systems. The physical structuring of the network involved the formation of intermolecular crosslinking between the alginate and glycine molecules, resulting in a three-dimensional structure. This structure provided a scaffold for the SSD crystal to be confined and prevented it from diffusing out of the network.

Compared to previous approaches that focused on the thickening or encapsulation of PCM materials, this physical structuring approach provides a more stable and reliable method for confining the PCM material. The results of this study suggest that physical structuring using 3D networks can be a promising approach for developing PCM systems with improved performance and stability (Table 1).

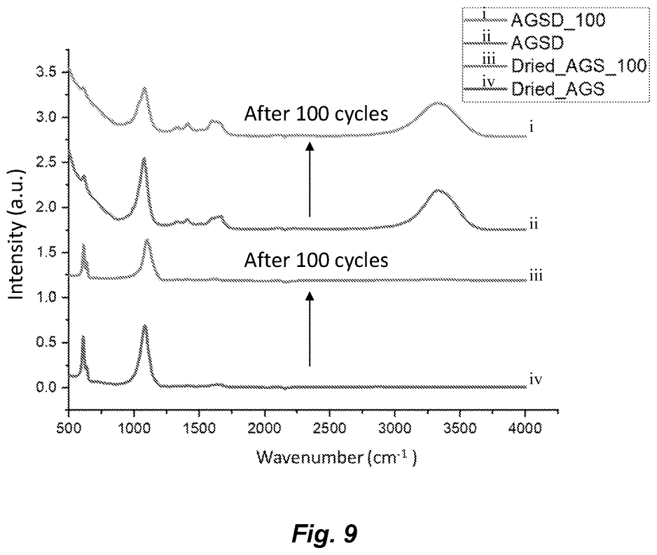

The FT-IR spectrum indicates that the hydrogel shows almost no changes after 100 cycles (FIG. 9). This could be due to the stability of the chemical bonds within the hydrogel network, which allows it to maintain its structural integrity even after repeated cycles of use. The FT-IR spectrum would show consistent peaks and bands, indicating that the chemical composition of the hydrogel remains unchanged over time.

Additionally, the hydrogel may have been designed with cross-linking agents or other stabilizing components that help to maintain its structure and properties. These components could prevent the hydrogel from degrading or breaking down during use, allowing it to withstand multiple cycles of use without significant changes.

TABLE 1
Characteristics of other phase change materials.

| | | | Degree | | | | |
|---|---|---|---|---|---|---|---|
| | | | of super | | | | |
| | Tₘ | T_{f} | cooling | Hₘ | H_{f} | | |
| Sample | [° C.] | [° C.] | [° C.] | [J/g] | [J/g] | Thermal cycling stability | Method |
| Na₂SO₄•10H₂O + | 25.8 | 17.8 | 8 | 52.3 | 26.1 | Dropping 46.2% in latent | DSC |
| 1% Na₂B₄O₇ - | | | | | | heat during melting after | |
| 2 cycle | | | | | | 2 cycle, Dropping 45.9% | |
| | | | | | | in latent heat during | |
| | | | | | | freezing after 2 cycles | |
| Na₂SO₄•10H₂O + | 25.4 | 17.2 | 8.2 | 23.3 | 1.5 | Dropping 76.1% in latent | DSC |
| 1% Na₂B₄O₇ - | | | | | | heat during melting after | |
| 3 cycle | | | | | | 3 cycle, Dropping 96.9% | |
| | | | | | | in latent heat during | |
| | | | | | | freezing after 3 cycles | |
| Na₂SO₄•10H₂O + | 23.58 | 14.02 | | 100.1 | 71.1 | Dropping 9.2% in latent | DSC |
| Na₂CO₃•10H₂O + | | | | | | heat during melting after | |
| Expanded | | | | | | 100 cycles, Dropping | |
| vermiculite - 100 | | | | | | 10.7% in latent heat | |
| cycle | | | | | | during freezing after 100 | |
| | | | | | | cycles | |
| Na₂SO₄•10H₂O + | 33.7 | −5 | | 100.9 | 58.5 | Dropping 19.7% in | DSC |
| MPCM3 - 100 | | | | | | latent heat during | |
| cycle | | | | | | melting after 100 cycles, | |
| | | | | | | Dropping 20.9% in | |
| | | | | | | latent heat during | |
| | | | | | | freezing after 100 cycles | |
| Na₂SO₄•10H₂O - | | | | 208.5 | | Dropping 9.5% in latent | DSC |
| 200 cycle | | | | | | heat during melting after | (3K/min) |
| | | | | | | 200 cycles | |
| Na₂SO₄•10H₂O - | | | | 186.05 | | Dropping 19.2% in | DSC |
| 500 cycle | | | | | | latent heat during | (3K/min) |
| | | | | | | melting after 500 cycles | |

Rheological analysis of hydrogel compositions. Glycine is a zwitterionic amino acid, meaning it contains both a positively charged amino group (—NH₃⁺) and a negatively charged carboxyl group (—COO⁻) at neutral pH. These charged groups can participate in chemical reactions with other functional groups, such as those found in the crosslinking agent and the polymer matrix of the hydrogel.

In the presence of a crosslinking agent, glycine can form covalent bonds with both the crosslinking agent and the polymer matrix. This crosslinking increases the density of the hydrogel network, resulting in a higher modulus and viscosity. The covalent bonds formed by glycine with the crosslinking agent and polymer matrix also provide greater stability to the hydrogel network, which can prevent degradation and improve mechanical properties over time.

In contrast, hydrogels without glycine may have fewer crosslinks and a less dense network structure. This can result in lower modulus and viscosity, as well as a lower overall stability. Additionally, the absence of glycine may result in a lower number of crosslinks and a less uniform distribution of crosslinks throughout the hydrogel matrix, which can lead to heterogeneous mechanical properties and a less stable hydrogel network.

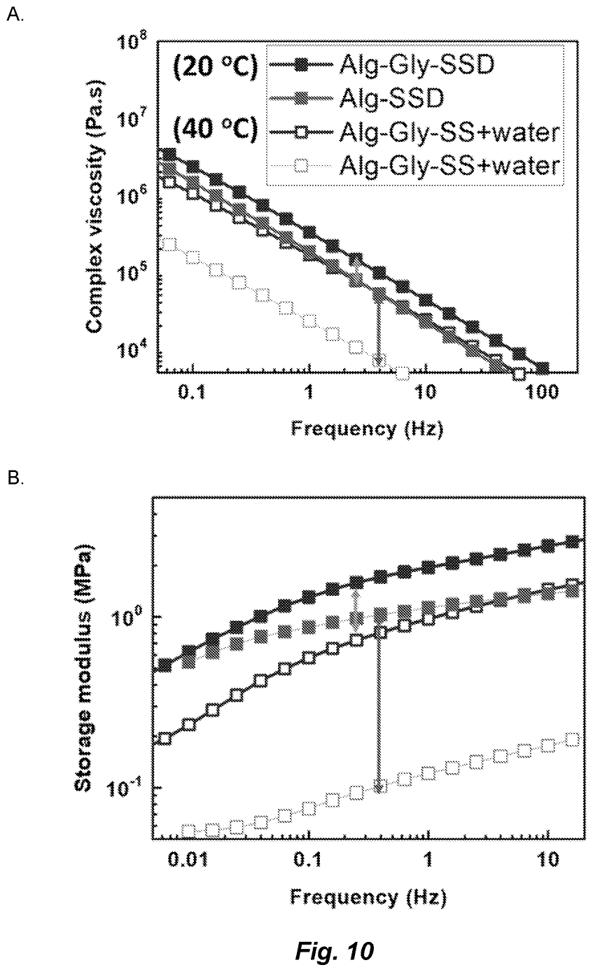

The modulus of a hydrogel is decreased due to the melting of SSD, the strong network provided by glycine could hold the liquid phase of SSD, minimizing the reduction in modulus compared to a hydrogel without glycine. In this scenario, the presence of glycine could help to maintain the structural robustness of the hydrogel by preventing the loss of the liquid phase (FIG. 10).

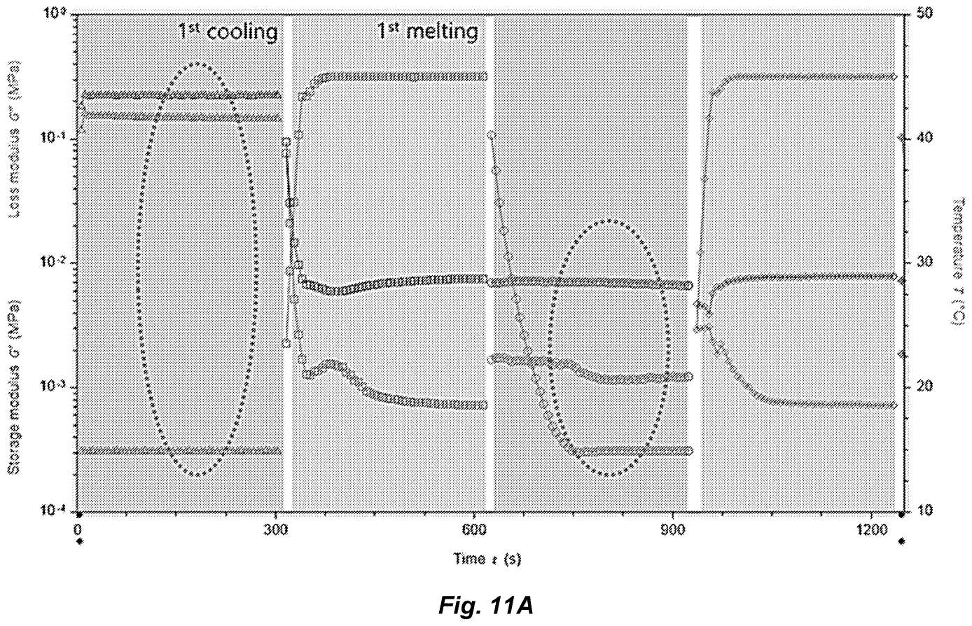

The hydrogel without glycine does not recover its modulus after a cycle, which may be due to the lack of nucleation sites for crystal growth. Glycine is known to act as a nucleating agent for SSD crystals, which can promote crystal formation and aid in the recovery of the hydrogel's modulus after a cycle (FIG. 11).

Without glycine, the hydrogel may not have enough nucleation sites for the formation of SSD crystals. As a result, the SSD crystals may not form or grow efficiently during the recovery phase, leading to a lack of recovery in the hydrogel's modulus.

Commercial uses. The invention has potential commercial uses in various fields that require thermal energy storage, such as building and construction, transportation, and electronics industries. Factors which motivate advancements in the field include: a) Reducing peak energy demand: PCM-based systems can store excess thermal energy during off-peak periods, such as at night, and release it during peak periods, such as during the day. This can reduce the need for conventional heating and cooling systems during peak periods, which can result in significant energy savings; 2) Reducing energy consumption: By absorbing and releasing heat, PCMs can help regulate indoor temperatures, reducing the need for conventional heating and cooling systems. This can lead to reduced energy consumption and lower energy bills; 3) Improving thermal comfort: PCM-based systems can help maintain thermal comfort for occupants by reducing temperature fluctuations and improving air quality. This can result in improved occupant satisfaction and productivity; and 4) Supporting renewable energy systems: PCM-based systems can be integrated with renewable energy sources, such as solar or wind, to store excess energy and use it when needed. This can help reduce the reliance on fossil fuels and support the transition to a more sustainable energy system.

The stable 3D network formed by the combination of alginate and glycine can be used to develop advanced and efficient thermal energy storage systems. These systems can be integrated into buildings to reduce energy consumption by regulating indoor temperature, leading to reduced energy costs and carbon emissions. Specifically, When the stable and effective thermal storage performance of this material can be utilized for building insulation, The ability to maintain a stable temperature in buildings can greatly reduce the energy consumption required for heating and cooling, leading to cost savings for building owners and reduced energy consumption for the environment.

Other potential commercial uses include in the field of refrigeration and cooling, where PCMs can be used to regulate temperatures in refrigeration units and cooling systems. Moreover, In the transportation industry, this material combination is a promising candidate for use in transportation and storage of temperature-sensitive goods, such as food and pharmaceuticals. The ability to maintain a stable temperature during transport and storage can greatly improve the shelf-life of these goods and reduce the risk of spoilage, resulting in cost savings for businesses and reduced waste.

The electronics industry can also benefit from the invention by using it to develop thermal energy storage systems for electronic devices such as computers, smartphones, and tablets. These systems would help regulate the temperature of the devices, leading to improved performance and longer lifetimes.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Methods

T-history and differential scanning calorimetry (DSC) are two commonly used techniques in the field of phase change materials (PCMs) to measure the thermal properties of a material during the melting and solidification processes.

T-history is a method for measuring the melting and solidification temperatures of a PCM material. In this method, a small sample of the PCM is placed in a container, which is then heated or cooled at a controlled rate. The temperature of the sample is monitored as it undergoes melting or solidification, and the temperature data is recorded to create a T-history curve. This curve shows the melting and solidification temperatures of the PCM material, as well as any supercooling or undercooling that may occur during the phase change process.

DSC is another method for measuring the thermal properties of a PCM material. In this method, a small sample of the PCM is placed in a sealed container, which is then heated or cooled at a controlled rate. The energy required to maintain a constant temperature is measured and recorded, creating a DSC curve. The DSC curve shows the heat flow and energy changes that occur during the melting and solidification processes of the PCM material, providing information about the enthalpy, specific heat, and phase transition temperatures of the material.

### Example 2. Synthesis of a Phase Change Hydrogel

### Synthesis Steps:

1. Added about 3.23 g to about 4.41 g of Sodium sulfate to a vessel.
2. Added about 6.77 g of deionized water to the vessel and ensured that the sodium sulfate solids were at the bottom of the solution to prevent aggregation.
3. Added about 0.2 g to about 0.5 g of glycine to the vessel.
4. Stirred the above solution at a temperature of about 50° C. to about 70° C. for about 30 minutes.
5. Cooled the solution to room temperature while stirring.
6. Gradually added about 0.6 g to about 1.3 g of Alginate to the solution while stirring. Therefore, the weight ratio of each ingredient in the composition based on water as 1 is:
Sodium sulfate: about 0.475 to about 0.645.
Glycine: about 0.0295 to about 0.0736.
Alginate: about 0.088 to about 0.191.

TABLE 2
Hydrogel compositions and properties.
Composition of Alg-Gly-SSD Hydrogel

| Weight % | Composition 1 | Composition 2 | Composition 3 | |
|---|---|---|---|---|
| Sodium Sulfate | 32.3% | 32.3% | 44% | |
| Alginate | 10% | 7% | 7% | |
| Glycine | 3% | 4% | 4% | |
| | | Average gravimetric | | |
| | | energy density (J/g) | | Degree of |
| | Density | Melting | Freezing | supercooling |
| Composition | (kg/m3) | T-H | T-H | (° C.) |
| 1 | 1316 | 101 | 91 | 5.17 |
| 3 | 1297 | 107 | 106 | 3.72 |
| 3 | 1275 | 66 | 44 | 12.5 |

TABLE 3
Thermal conductivity of other PCMs.

| | k | |
|---|---|---|
| Material name | [W/m-K] | |
| Octadecane | 0.148 | (l) |
| | 0.358 | (s) |
| Paraffin | 0.16 | (l) |
| | 0.18 | (s) |
| Eicosane | 0.157 | (l) |
| | 0.39 | (s) |
| Polyethylene glycol (PEG) | 0.3 | |
| Octadecanol | 0.175 | (l) |
| | 0.273 | (s) |

### Example 3. Commercial Applications

A water-heater system incorporating a phase change material was tested. A simulation model under various conditions was used to evaluate the performance of the water-heater system. We captured the heat transfer rate of water for various phase change materials that demonstrated the effectiveness of the hydrogel described herein. The water-heater system requires kg-scale hydrogel for which we demonstrated bulk scale synthesis of the hydrogel.

The hydrogel can be applied to a water-heater system and HVAC systems for building thermal management because the hydrogel can be prepared in a bulk scale for commercial use. The bulk-scale performance of the hydrogel has been verified by simulation models for the water-heater system under various conditions.

A water-ice system for thermal energy storage can be replaced with a system using the hydrogel described herein because the hydrogel is also non-toxic and economical. The thermal energy storage density of hydrogel is comparably high, and it is chemically stable over 100 cycles. The water-ice system requires tight sealing to prevent water leakage and must account for a huge density change in its design. However, a thermal energy storage system using the hydrogel has higher viscosity than water, and therefore, risk of leakage is minimal.

A tube in the form of a helical coil can be used as a heat exchanger incorporating the viscous hydrogel described herein. The helical coil can be used for a compact heat exchanger system. Such a helical coil has a large heat transfer area for high heat transfer rate between the hydrogel and a working fluid in the tube. For a intricate heat exchanger system, the hydrogel can be incorporated because the hydrogel is adaptable to complex tube geometries. For example, a working fluid can pass through a channel inside the hydrogel because the hydrogel can adhere to the inner wall of a tube.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

1. A phase change hydrogel comprising a polysaccharide, sodium sulfate, and molecules of an amino acid, wherein the amino acid is at about its isoelectric point.

2. The phase change hydrogel of claim 1, wherein the polysaccharide is alginate.

3. The phase change hydrogel of claim 1, wherein the polysaccharide is cross-linked with the amino acid.

4. The phase change hydrogel of claim 1, wherein the amino acid is glycine.

5. The phase change hydrogel of claim 1, wherein the amino acid is a zwitterion.

6. The phase change hydrogel of claim 1, wherein the hydrogel comprises water and the sodium sulfate is hydrated.

7. The phase change hydrogel of claim 1, wherein the hydrogel has a pH of about 4.5 to about 8.0.

8. The phase change hydrogel of claim 1, wherein the hydrogel has a weight ratio of the alginate to the amino acid of about 1:0.3 to about 1:0.1.

9. The phase change hydrogel of claim 1, wherein the hydrogel has a weight ratio of the alginate to the amino acid of about 1:0.9 to about 1:0.3.

10. The phase change hydrogel of claim 1, wherein the amino acid has a weight percent of about 3 wt. % to about 16 wt. % relative to the weight of sodium sulfate (Na₂SO₄).

11. The phase change hydrogel of claim 10, wherein the amino acid has a weight percent of about 4 wt. %, about 7 wt. %, about 11 wt. %, or about 15 wt. %, relative to the weight of sodium sulfate (Na₂SO₄).

12. The phase change hydrogel of claim 1, wherein the polysaccharide has a weight percent of about 13 wt. % to about 41 wt. % relative to the weight of sodium sulfate (Na₂SO₄).

13. The phase change hydrogel of claim 12, wherein the polysaccharide has a weight percent of about 14 wt. %, about 19 wt. %, about 30 wt. %, or about 40 wt. %, relative to the weight of sodium sulfate (Na₂SO₄).

14. The phase change hydrogel of claim 1, wherein the sodium sulfate (Na₂SO₄) has a weight percent of about 47 wt. % to about 65 wt. % relative to a weight of water in the hydrogel.

15. The phase change hydrogel of claim 1, wherein the amino acid is glycine, and the polysaccharide is alginate, wherein the alginate is crosslinked with the glycine.

16. The phase change hydrogel of claim 15, wherein the weight ratio of the sodium sulfate, the alginate, and the glycine is about 1 part sodium sulfate (Na₂SO₄), about 0.13 parts to about 0.4 parts alginate, and about 0.04 parts to about 0.16 parts glycine.

17. The phase change hydrogel of claim 15, wherein relative to an amount of water in the hydrogel the weight ratio the sodium sulfate, the alginate, and the glycine is: 1 part water, about 0.4 parts to about 0.7 parts sodium sulfate (Na₂SO₄), about 0.08 parts to about 0.2 parts alginate, and about 0.02 parts to about 0.08 parts glycine.

18. A method for releasing and storing thermal energy comprising:
a) adapting a heat exchanger to the phase change hydrogel of claim 1; and
b) exposing the hydrogel to an environment wherein the temperature fluctuates;
wherein the hydrogel releases thermal energy to the heat exchanger when the hydrogel solidifies; and
the hydrogel withdraws thermal energy from the heat exchanger when it melts.

19. The method of claim 18, wherein the amino acid is glycine, and the polysaccharide is alginate, wherein the alginate is crosslinked with the glycine.

20. The method of claim 18, wherein the temperature fluctuates by about +20° C. from the melting temperature of the hydrogel.
